(19) United States
(12) Patent Application Publication
(10) Pub. No.: US 2026/0366440 A1
(43) Pub. Date: Nov. 19, 2026

(54) SLIDING CAM AND SLIDING-CAM CAMSHAFT

(71) Applicants: thyssenkrupp Dynamic Components GmbH, Ilsenburg (Harz) (DE); thyssenkrupp AG, Essen (DE)

(72) Inventors: Jens SCHIRMER, Chemnitz (DE); Markus HAERTEL, Zwickau (DE)

(73) Assignees: thyssenkrupp Dynamic Components GmbH, Ilsenburg (Harz) (DE); thyssenkrupp AG, Essen (DE)

(21) Appl. No.: 19/138,031

(22) PCT Filed: Dec. 8, 2023
(86) PCT No.: PCT/EP2023/084855

§ 371 Date: Jun. 11, 2025

(30) Foreign Application Priority Data
Dec. 12, 2022 (DE) 10 2022 133 027.3

(51) Int. Cl. F01L 13/00; F01L 1/047

(52) U.S. Cl. CPC F01L 13/0036; F01L 1/047; F01L 2001/0473; F01L 2013/0052

(57) ABSTRACT

A sliding cam for a sliding camshaft comprises a support tube, a first functional element, and a second functional element, wherein the functional elements are arranged directly next to one another on the support tube and extend in the axial direction over a joining portion, wherein the joining portion comprises a first joining region in which the first functional element is fastened on the support tube by means of a press connection, wherein the joining portion comprises a second joining region in which the second functional element is fastened on the support tube by means of a press connection, and wherein an undercut is arranged between the first joining region and the second joining region.

The present invention relates to a sliding cam as claimed in the preamble of claim 1, as well as a sliding camshaft as claimed in the preamble of claim 7.

A sliding camshaft essentially comprises a base shaft and at least one sliding cam arranged axially displaceably thereon. A connecting apparatus is arranged between the sliding cam and the base shaft, which is designed to transmit a torque between the base shaft and the sliding cam. Likewise, the connecting apparatus must ensure axial displacement of the sliding cam on the base shaft. A sliding toothing, for example, can be used as a connecting apparatus.

The sliding cam as such comprises a support tube and at least one first functional apparatus and one second functional apparatus. The first functional apparatus can be, for example, a cam package. The second functional apparatus can be, for example, an adjusting link.

The cam package comprises at least two cams with different cam contours. An adjusting apparatus, such as an actuator or a push rod or adjusting element, acts on the displacing link, allowing either the first cam or the second cam to be engaged with the respective gas exchange valve of an internal combustion engine, thus adapting the gas exchange to the respective operating situation. Further details are well known to the person skilled in the art.

The sliding cams can be built, wherein the functional elements are usually pressed onto the support tube, i.e. fixed by means of a press connection.

In this case, it is provided that the functional elements are arranged directly next to one another on the support tube and extend in the axial direction over a joining portion, wherein the joining portion comprises a first joining region in which the first functional element is fastened on the support tube by means of a press connection, wherein the joining portion comprises a second joining region in which the second functional element is fastened on the support tube by means of a press connection.

The press connection must ensure that the intended torques between the support tube and the functional element, in particular between the support tube and the cam package, can be transmitted.

In particular, if two functional elements are connected to the support tube directly next to each other by means of a press connection, there is a risk of mutual interference, so that the torque that can be transmitted by the functional elements can be reduced.

The object of the present invention is accordingly to propose an improved sliding cam, in particular to propose a sliding cam in which a reduction in the transmittable torque influenced by the press connections of adjacent functional elements can be excluded or at least reduced.

According to the invention, this object is achieved by a sliding cam having the characterizing features of claim 1. Due to the fact that an undercut is arranged between the first joining region and the second joining region, a reduction in the torque transmittable by the functional elements caused by the two press connections can be avoided or at least reduced. The press connection between the functional element(s) and the support tube is relieved. The transmittable torque of individual components on the support tube is increased, as the tensile stresses on the surface of the support tube are not introduced directly into the adjacent connection. This allows the stresses to be shifted beneath the respective functional elements, and additional support in the respective joining region increases the pressure. However, the press overlaps of the press connections influence each other to a lesser extent. An undercut between the adjacent press overlaps decouples the surface tensions in both press regions. In other words, the stress profile on the surface of the support tube is interrupted. With respect to the joining regions, this can increase the radial stiffness of the support tube. This can bring about an increase in the transmittable torque of individual functional elements on the support tube.

Further advantageous configurations of the proposed invention will become apparent in particular from the features of the subordinate claims. The subject matter and features of the various claims can, in principle, be combined with one another as desired.

In one advantageous configuration of the invention, it can be provided that the undercut is configured as a circumferential groove in the support tube. A circumferential groove is correspondingly easy to introduce.

In a further advantageous configuration of the invention, it can be provided that the undercut is arranged in the axial direction directly next to the joint of the functional elements. The immediate proximity of the undercut to the joint of the two functional elements contributes advantageously to the relief of the press connection between the functional element(s) and the support tube.

In a further advantageous configuration of the invention, it can be provided that the first functional element is configured as a cam package and the second functional element as an adjusting link. The preferred application of the present invention lies within the scope of such a pairing of functional elements.

In a further advantageous configuration of the invention, it can be provided that the functional element is configured as a cam, cam package, adjusting link, bearing ring, pump cam, sensor wheel, etc. In principle, the invention is also applicable to other functional elements or pairings of functional elements.

In a further advantageous configuration of the invention, it can be provided that the cam package is formed in one piece, as a result of which assembly is simplified.

A further object of the present invention is to propose an improved sliding camshaft, in particular to propose a sliding camshaft with a sliding cam, in which a reduction in the transmittable torque influenced by the press connections of adjacent functional elements can be excluded or at least reduced.

According to the invention, this object is achieved by a sliding cam having the characterizing features of claim 7. With regard to the advantages resulting from the use of a sliding cam according to the invention, reference can be made to the above statements.

Further advantageous configurations of the proposed invention will become apparent in particular from the features of the subordinate claims. The subject matter and features of the various claims can, in principle, be combined with one another as desired.

In a further advantageous configuration of the invention, it can be provided that a connecting apparatus configured to transmit a torque and to axially displace the sliding cam is provided between the base shaft and the sliding cam.

In a further advantageous configuration of the invention, it can be provided that the connecting apparatus is configured as a sliding toothing, wherein the sliding toothing comprises in particular an internal toothing on the sliding cam side in the opening of the sliding cam and an external toothing on the base shaft.

Further features and advantages of the present invention will become clear from the following description of preferred exemplary embodiments with reference to the accompanying illustrations. In the drawings:

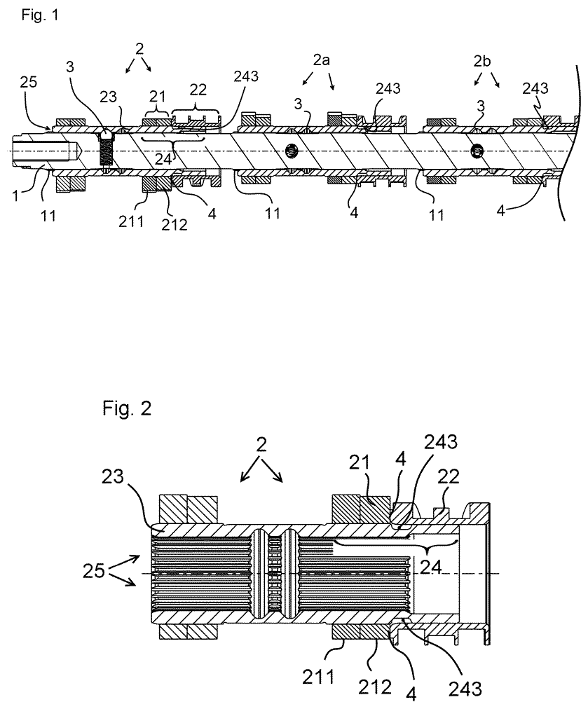

FIG. 1 shows a sliding camshaft according to the invention;

FIG. 2 shows a sliding cam according to the invention for a sliding camshaft according to the invention;

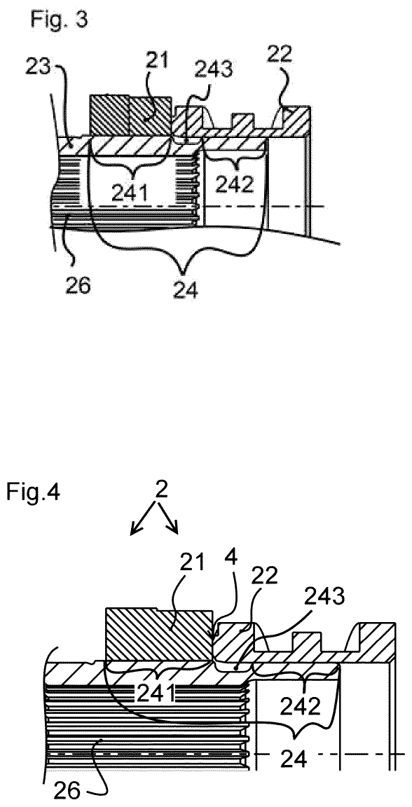

FIG. 3 shows an enlarged detailed view of a sliding cam according to the invention according to FIG. 2;

FIG. 4 shows an enlarged detailed view of an embodiment of the sliding cam according to the invention;

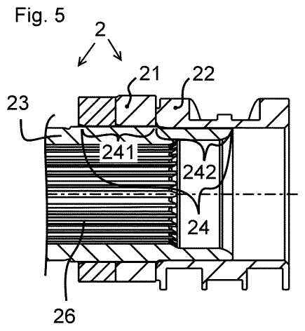

FIG. 5 shows a detailed view of a sliding cam according to the prior art.

The following reference signs are used in the illustrations:
1 Base shaft
2 Sliding cam
3 Latching device
4 Joint
11 External toothing
21 First functional element, in particular cam package
22 Second functional element, in particular adjusting link
23 Support tube
24 Joining portion
25 Opening
26 Internal toothing
211 First cam
212 Second cam
241 First joining region
242 Second joining region
243 Undercut

Features and details described in connection with a method naturally also apply in connection with the device according to the invention, and vice versa, so that with regard to the disclosure of the individual aspects of the invention, reference is always made to each other. Furthermore, a method according to the invention that may be described can be carried out with the device according to the invention.

The terminology used herein is for the purpose of describing particular embodiments only and is not intended to limit the disclosure. As used herein, the singular forms “a/an” and “the” are intended to include the plural forms as well, unless the context clearly indicates otherwise. It will also be understood that the terms “has” and/or “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated, listed elements.

Firstly, reference is made in particular to FIG. 1.

A sliding camshaft according to the invention essentially comprises a base shaft 1 with at least one sliding cam 2. In the present exemplary embodiment, three sliding cams 2, 2a, 2b are provided. The sliding cam 2 comprises an opening 25 for receiving the base shaft 1.

A connecting apparatus which is suitable for transmitting torque and axially displacing the sliding cam on the base shaft is provided between the sliding cam 2 and the base shaft 1. The connecting apparatus can be configured, for example, as a sliding toothing comprising an external toothing 11 on the base shaft side and an internal toothing 26 on the sliding cam side. However, other pairings, such as those based on non-circular cross-sections, flat surfaces, etc., are also possible.

It can furthermore preferably be provided that a latching device 3 is provided between the sliding cam 2 and the base shaft 1. The latching device 3 is configured to releasably fix the sliding cam selectively in a first axial position or a second axial position.

In the following, reference is made in particular to FIGS. 2 and 3.

The sliding cam 2 essentially comprises a support tube 23 as well as a first functional element 21 and at least one second functional element 22, wherein the functional elements 21, 22 are connected to the support tube 23 by means of a press connection. The first functional element 21 and the second functional element 22 are arranged directly next to one another in the axial direction on the support tube 23 and extend in the axial direction over a joining portion 24.

The joining portion 24 in turn comprises a first joining region 241, in which the first functional element 21 is fastened on the support tube 23 by means of a press connection. Furthermore, the joining portion 24 comprises a second joining region 242, in which the second functional element 22 is fastened on the support tube 23 by means of a press connection.

The functional elements are preferably mounted on joint 4, at least one end face of the functional element is directly opposite the end face of the other joint element.

According to the invention, it is provided that an undercut 243 is arranged between the first joining region 241 and the second joining region 242. The circumferential undercut 243 can also be referred to as a circumferential groove or diameter reduction.

The resulting advantage is a reduction in the load on the press connection, in particular between the functional element 21 and the support tube 23. This tends to increase the transmittable torque of individual components, in particular the functional elements, on the support tube, since the tensile stresses on the surface of the support tube are not directly transmitted into the adjacent connection. This allows the stresses to be shifted beneath the respective functional elements, and additionally, an increase in pressure occurs due to the additional supporting effect in the respective joining region. In order to increase the pressing between the two functional elements 21, 22, the joint length of both functional elements 21, 22 should not be changed. If a functional element, for example, the second functional element 23 as shown in FIGS. 3 and 4, projects beyond the undercut 243, the press connection of the second functional element 22 is shifted by the amount of the relief 243, thus maintaining the original joining length. It is clear to the person skilled in the art that the support tube 23 must be formed to be correspondingly axially longer. If this is not desired, for example, for weight reasons, a customized design of the press connection can be implemented. In relation to the joining length, decoupling the press connections from one another can increase the radial stiffness of the support tube 23 in the edge regions. Although the radial stiffness in the undercut 243 is lower, the displacement of the second joining region 242 (the second press connection) additionally supports this spring behavior. Stresses arise from displacements and stiffnesses. An increase in the pressure can be achieved with the same outer diameter ratio and the same joining length, for example, by increasing the stiffness of the shaft.

It is preferably provided that the undercut 243 is arranged in the axial direction directly next to the joint 4 of the functional elements 21, 22, so that one of the functional elements or the functional element 23 projects beyond the undercut 243.

A cam or an adjusting link, for example, can be used as a functional element. In the present exemplary embodiment, the first functional element 21 is configured as a cam package, and the second functional element 22 as an adjusting link. The cam package essentially comprises a first cam 211 and a second cam 212, which differ in their cam geometry. The cams 211, 212 can also have the same cam geometry but differ in their angular position relative to one another. A bearing ring, a pump cam, a sensor wheel, etc., which can be fastened on the support tube in the manner outlined above, can also be used as a functional element.

The sliding camshaft, also according to the invention, comprises a sliding cam 2 according to the invention. Preferably, all sliding cams of the sliding camshaft are configured as sliding cams according to the invention. The function of such a sliding camshaft is sufficiently known to the person skilled in the art. An actuator (not represented) acts on the sliding link 22, so that either the first cam 211 or the second cam 212 of the cam package 21 can be brought into engagement with the respective gas exchange valve (not represented) of an internal combustion engine, so that the gas exchange can be adapted to the respective operating situation.

Reference is made below in particular to FIG. 4.

In a further advantageous configuration of the invention, it can be provided that the first functional element 21 is formed as a one-piece cam package. The undercut 243 is projected over by the second functional element 22.

FIG. 5 shows a detailed view of a sliding cam 2 according to the prior art, which has the following. The sliding cam 2 comprises the first functional element 21, the second functional element 22, and the support tube 23. The joining section 24, comprising the first joining region 241 and the second joining region 242, is also visible. Reference numeral 26 denotes the sliding toothing. Accordingly, no undercut is arranged between the first joining region 241 and the second joining region 242.

1-9. (canceled)

10. A sliding cam for a sliding camshaft, comprising:
a support tube; and
a first functional element and a second functional element;
wherein the first and second functional elements are arranged directly next to one another on the support tube and extend in the axial direction over a joining portion;
wherein the joining portion includes a first joining region in which the first functional element is fastened to the support tube by a first press connection, and a second joining region in which the second functional element is fastened on the support tube by a second press connection;
wherein an undercut is arranged between the first joining region and the second joining region.

11. The sliding cam as claimed in claim 10, wherein the undercut is configured as a circumferential groove in the support tube.

12. The sliding cam as claimed in claim 10, wherein the undercut is arranged in the axial direction directly next to the joint of the functional elements.

13. The sliding cam as claimed in claim 10, wherein the first functional element is a cam package and the second functional element is an adjusting link.

14. The sliding cam as claimed in claim 10, wherein the first and second functional elements are each a cam, cam package, adjusting link, bearing ring, pump cam, or sensor wheel.

15. The sliding cam as claimed in claim 14, wherein the cam package is formed in one piece.

16. A sliding camshaft, comprising:
a base shaft; and
a sliding cam as claimed in claim 10, wherein the sliding cam has an opening for receiving the base shaft.

17. The sliding camshaft as claimed in claim 16, wherein a connecting apparatus configured to transmit a torque and to axially displace the sliding cam is provided between the base shaft and the sliding cam.

18. The sliding camshaft as claimed in claim 17, wherein the connecting apparatus is configured as a sliding toothing, wherein the sliding toothing comprises an internal toothing on the sliding cam side in the opening of the sliding cam and an external toothing on the base shaft.
